(19) United States
(12) Patent Application Publication
(10) Pub. No.: US 2010/0283722 A1
(43) Pub. Date: Nov. 11, 2010

(54) ELECTRONIC APPARATUS INCLUDING A COORDINATE INPUT SURFACE AND METHOD FOR CONTROLLING SUCH AN ELECTRONIC APPARATUS

(75) Inventor: Karl Ola THORN, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/437,658

(22) Filed: May 8, 2009

(51) Int. Cl. G09G 5/00

(52) U.S. Cl. 345/156

(57) ABSTRACT

An electronic apparatus includes a coordinate input surface on which at least a finger of a user can be placed, a first position estimating unit and a second position obtaining unit. The first position estimating unit is for estimating the position, here referred to as first position, of at least one object placed on the coordinate input surface. The second position obtaining unit is for obtaining an estimation of the position, here referred to as second position, at which a user is looking on the coordinate input surface. The apparatus is configured to be controlled at least based on the combination of the estimated first position and the estimated second position. The invention also relates to a system including such an apparatus, a method for controlling such an apparatus, and a computer program therefor.

### TECHNICAL FIELD

The present invention relates to an electronic apparatus including a coordinate input surface, to a system including such an apparatus, to a method of controlling such an apparatus, and to a computer program comprising instructions configured, when executed on a computer, to cause the computer to carry out the above-mentioned method. In particular, the invention notably relates to interactions between a user and an electronic apparatus and to the control of the apparatus in accordance or in response to these interactions.

### BACKGROUND

Electronic apparatuses are used for various applications involving users interacting with such apparatuses. They are used to efficiently confer and exchange more and more information with their users, both as input and output. This is notably carried out through the use of a coordinate input surface which may be arranged above a display. For instance, electronic apparatuses with touch screens enable users to conveniently select targets, such as web links, with an object such as a finger placed on, i.e. touching, an outer surface above the display.

For instance, such electronic apparatuses may be wireless communication terminals, such as mobile phones to transport voice and data.

It is desirable to provide electronic apparatuses, systems, methods and computer programs to improve the efficiency and precision of interactions between users and electronic apparatuses including coordinate input surfaces, while at the same time aiming to confer as much information as possible to the users.

### SUMMARY

In order to meet, or at least partially meet, the above-mentioned objectives, electronic apparatuses, methods and computer programs in accordance with the invention are defined in the independent claims. Advantageous embodiments are defined in the dependent claims.

In one embodiment, an electronic apparatus includes a coordinate input surface, a first position estimating unit, and a second position obtaining unit. The coordinate input surface is such that at least a finger of a user can be placed thereon. The first position estimating unit is configured for estimating the position, here referred to as first position, of at least one object placed on the coordinate input surface. The second position obtaining unit is configured for obtaining an estimation of the position, here referred to as second position, at which a user is looking on the coordinate input surface. The apparatus is configured to be controlled at least based on the combination of the estimated first position and the estimated second position.

The coordinate input surface is thus a surface on which at least a finger of a user can be placed. Moreover, the coordinate input surface is an outer surface of the apparatus arranged with respect to other parts of the apparatus so that the coordinate of an object placed on the surface can be used as an input in the apparatus, i.e. to control the apparatus. In the apparatus, the first position estimating unit is in charge of estimating the coordinate, i.e. the position, here referred to as first position, of the object placed on the coordinate input surface.

A finger can be placed on the coordinate input surface. This is a property of the coordinate input surface in the sense that the coordinate input surface is an outer surface physically reachable by a finger. The object of which the first position estimating unit is configured to estimate the position may be the finger or may be another object, such as a stylus or pen. That is, the following applies. In one embodiment, the first position estimating unit is capable of detecting the position of a finger placed on the coordinate input surface and is also capable of detecting the position, on the coordinate input surface, of an object other than a finger. In another embodiment, the first position estimating unit is capable of detecting the position of a finger placed on the coordinate input surface, but is not capable of detecting the position, on the coordinate input surface, of any or some other object than a finger. In yet another embodiment, the first position estimating unit is not capable of detecting the position of a finger placed on the coordinate input surface, but is capable of detecting the position, on the coordinate input surface, of another type of object than a finger.

In one embodiment, the apparatus further includes a display, and the coordinate input surface is an outer surface above the display, i.e. arranged above the display. The coordinate input surface may be the outer surface of a transparent or sufficiently transparent layer above the display, so that a user looking at the coordinate input surface can see the content of what is displayed on the display.

This enables the input provided by a user through the coordinate input surface using an object, such as a finger, a stylus or an input pen, to be corrected, interpreted or complemented based on an estimation of the position at which, or towards which, the user is looking on the coordinate input surface. The position at which, or towards which, the user is looking on the coordinate input surface corresponds to a position at which, or towards which, the user is looking on the display. This embodiment in turn enables to provide a denser set of possible interactions with the coordinate input surface and with the display, i.e. in the content of the image on the display, by providing additional means to discriminate, i.e. disambiguate, between these multiple sources of interactions that a user can have with the coordinate input surface and the display. In particular, smaller targets can be provided on the display.

In other words, this enables to provide a denser structure of information and selectable targets on the display, compared to existing “touch-screen-based” or “stylus-upon-screen-based” user interfaces. The estimation of the direction of user gaze is used to discriminate, i.e. disambiguate, between the areas of the display.

The invention also extends to an apparatus which does not include a display, and wherein the coordinate input surface comprises marks, figures or symbols, such as permanent marks, figures or symbols, formed or written thereon. The coordinate input surface may also be such that a user can see through the coordinate input surface, and, underneath the coordinate input surface, marks, figures or symbols, such as permanent marks, figures or symbols, are formed or written. In that embodiment also, the second position, i.e. the position where the user is looking at, or towards, on the coordinate input surface, may be used to disambiguate a user tactile (or stylus) input on the coordinate input surface.

A cursor within the display content is not an object that can be placed on the coordinate input surface, within the meaning of the invention. However, this does not exclude that embodiments of the invention may be combined with systems including cursors, such as mouse-controlled cursors, or systems wherein the estimate gaze direction is also used to control a cursor belonging to the display content without using the estimated first position (wherein the cursor is for instance purely gaze-controlled, or both mouse- and gaze-controlled).

In one embodiment, the apparatus further includes an image obtaining unit for obtaining at least one image of a user's face facing the coordinate input surface and a second position estimating unit for estimating, based on the at least one image, the second position. In this embodiment, the second position estimating unit included within the apparatus enables to conveniently estimate, within the apparatus, the second position, i.e. the position at which the user is looking on the coordinate input surface.

In one embodiment, the apparatus further includes an image capturing unit for capturing the at least one image. This embodiment enables a convenient capture of the image or images to be used for estimating the second position using the image capturing unit included in the apparatus. In one embodiment, the image capturing unit is a camera or a video camera formed or integrally formed within the apparatus and capable of capturing one or more images of the environment in front of the coordinate input surface. In one embodiment, the image capturing unit includes more than one camera or video camera. An existing, built-in camera of the apparatus may be used, such as a video call camera. The camera or cameras may also be combined with a proximity sensor.

In one embodiment, the apparatus is such that the image capturing unit is arranged to capture the at least one image when a condition is met. The condition depends on the content of what is displayed on the display, here referred to as display content, and the estimated first position.

This embodiment enables to switch on or activate the image capturing unit, such as the camera, only when it is determined, based on the display content and the estimated first position, that the user's finger (or other object, such as a stylus or input pen) is located at a point (or in a region) on the coordinate input surface corresponding to a particular point (or a particular region) on the display with respect to the position of the different targets, such as links, buttons, icons, characters, symbols or the like, in the display content. The particular point (or particular region) with respect to the position of the different targets in the display content may correspond to a situation in which the precision of the input process would likely benefit from additional information to disambiguate the input.

This embodiment in turn enables to save computational resources and battery power since the image capturing unit need not be permanently switched on or activated.

In one embodiment, the apparatus is such that the condition (to cause the image capturing unit to capture one or more images) includes that at least two targets in the display content are within the predetermined distance of the estimated first position.

This embodiment enables to activate the image capturing unit in view of possibly resolving an ambiguity when a user's finger is positioned on the coordinate input surface above a point of the display which is close to at least two targets in the display content. Such finger position may be determined to mean that the user is as likely to have intended to activate the first target as to have intended to activate the second target. The image capturing process is therefore started when such an ambiguous situation arises. This embodiment thus enables the apparatus to timely, i.e. when needed, start the image capturing process when it is determined that there is room for improving the user interaction efficiency and precision.

In one embodiment, the apparatus is such that the display content includes at least one of a web page, a map and a document, and that the at least two targets are at least two links in the display content.

In one embodiment, the apparatus is such that the condition includes that the estimated first position is determined to be moving. In one embodiment, the condition includes that the estimated first position is determined to be moving at a speed above a predetermined speed. These embodiments enable to activate the image capturing process when the estimated first position is determined to be moving, i.e. when, depending on the display content, it may be ambiguous whether for instance the user wishes to select a particular target or the user wishes to carry out a panning operation on the display content.

A panning operation is here defined as scrolling up and down and/or left and right the content of the display screen, including moving the content of the display screen in any angular direction, and enables to manipulate documents that are larger than the size of the display at a given resolution.

In one embodiment, the apparatus is arranged to be controlled, when at least two targets in the display content are determined to be within the threshold distance of the estimated first position, by selecting one of the at least two targets based on the estimated second position.

This embodiment enables to effectively and precisely control the operation of the apparatus by interpreting users' inputs in an ambiguous situation. This may arise from users having difficulties, for instance due to neurodegenerative disorders but not limited thereto, to maintain a finger stationary at one point on the surface of the display. This may also arise due to the relatively small size of the targets in the display content.

In one embodiment, the apparatus is such that selecting one of the at least two targets based on the estimated second position includes selecting, among the at least two targets, the target being the closest to the estimated second position.

In one embodiment, the apparatus is arranged to be controlled, when the estimated first position is determined to be moving and the estimated second position is determined to be near an edge of a coordinate input surface, by panning the display content in the direction of the estimated second position. “Near an edge of a coordinate input surface” means here within a predetermined distance of an edge of a coordinate input surface.

This embodiment enables to interpret a user's action when the action consists in moving a finger on the coordinate input surface. The action may be interpreted as a panning command if the user simultaneously gazes in a direction where he or she wishes to pan the display content. In contrast, if it is determined that the position at which the user is looking on the coordinate input surface and display is not near an edge of the coordinate input surface, the apparatus may be controlled such as not to carry out a panning operation. The user may instead wish to select a target, and possibly perform a drag and drop operation.

In one embodiment, the coordinate input surface and the display of the apparatus together form a touch screen, and the object is a finger.

In one embodiment, the apparatus is at least one of a mobile phone, an audio player, a camera, a navigation device, an e-book device, a computer, a handheld computer, a personal digital assistant, a game console, and a handheld game console.

The invention also relates to a system including an apparatus including a coordinate input surface, a first position estimating unit, and a second position obtaining unit. At least a finger of a user can be placed on the coordinate input surface. The first position estimating unit is configured for estimating the position, here referred to as first position, of at least one object placed on the coordinate input surface. The second position obtaining unit is configured for obtaining an estimation of the position, here referred to as second position, at which a user is looking on the coordinate input surface. The apparatus is configured to be controlled at least based on the combination of the estimated first position and the estimated second position. The system further includes an image capturing unit arranged with respect to the apparatus so as to be capable of capturing at least one image of the a user's face facing the display of the apparatus, an image obtaining unit for obtaining the at least one image, and a second position estimating unit for estimating, based on the at least one image, the second position, wherein at least the image capturing unit is not integrally formed within the apparatus.

In this embodiment, the image capturing unit may be an external camera or a plurality of external cameras arranged to capture at least one image of at least part of the environment in front of the display of the apparatus. This may include for instance a webcam.

In one embodiment, the system is such that the image capturing unit, the image obtaining unit and the second position estimating unit are not integrally formed within the apparatus. In this embodiment, the apparatus is configured to receive or obtain an estimated second position computed outside the apparatus using the external image capturing unit. This may include for instance an external eye tracker.

The invention also relates to a method of controlling an electronic apparatus including a coordinate input surface on which at least a finger of a user can be placed. The method includes a step of estimating the position, here referred to as first position, of at least one object on the coordinate input surface. The method further includes a step of obtaining an estimation of the position, here referred to as the second position, at which a user is looking on the coordinate input surface. The method further includes a step of controlling the apparatus at least based on the combination of the estimated first position and the estimated second position.

In one embodiment, the method is a method of controlling an apparatus including a display, wherein the coordinate input surface is an outer surface above the display, i.e. arranged above the display.

The invention also relates to a computer program comprising instructions configured, when executed on a computer or on an electronic apparatus, to cause the computer or electronic apparatus respectively to carry out the above-mentioned method. The invention also relates to a computer-readable medium storing such a computer program.

### BRIEF DESCRIPTION OF THE DRAWINGS

Embodiments of the present invention shall now be described, in conjunction with the appended figures, in which:

FIG. 1a schematically illustrates an electronic apparatus in one embodiment of the invention;

FIG. 1b schematically illustrates a coordinate input surface and a display of an electronic apparatus in one embodiment of the invention;

FIG. 2 schematically illustrates an electronic apparatus and some of its constituent units in one embodiment of the invention;

FIG. 3 is a flowchart illustrating steps of a method in one embodiment of the invention, wherein the steps may be configured to be carried out by the apparatus of FIG. 2;

FIGS. 4a to 4c schematically illustrate situations wherein a first position and a second position may be estimated in an apparatus or method in one embodiment of the invention;

FIG. 5 schematically illustrates an apparatus and some of its constituent units in one embodiment of the invention, wherein the image obtaining unit and the second position estimating unit are included in the apparatus;

FIG. 6 is a flowchart illustrating steps of a method in one embodiment of the invention, wherein the steps may be configured to be carried out by the apparatus of FIG. 5;

FIG. 7 schematically illustrates an apparatus and some of its constituent units in one embodiment of the invention, wherein the image capturing unit is included in the apparatus;

FIG. 8 is a flowchart illustrating steps of a method in one embodiment of the invention, wherein the steps may be configured to be carried out by the apparatus of FIG. 7; and

FIG. 9 is a flowchart illustrating steps leading to switching on or activating the image capturing unit, or activation of the image capturing process, in one embodiment of the apparatus or method of the invention.

### DESCRIPTION OF SOME EMBODIMENTS

The present invention shall now be described in conjunction with specific embodiments. It may be noted that these specific embodiments serve to provide the skilled person with a better understanding, but are not intended to in any way restrict the scope of the invention, which is defined by the appended claims.

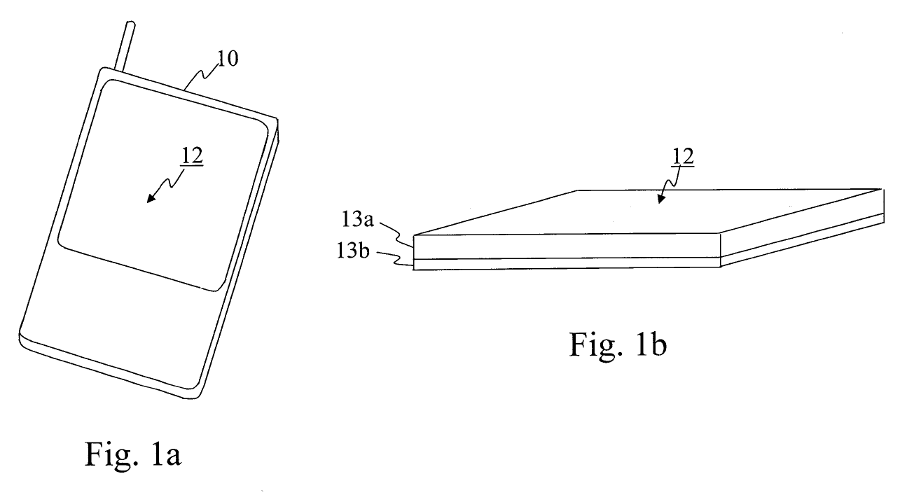

FIG. 1a schematically illustrates an apparatus 10 in one embodiment of the invention. The apparatus 10 includes a coordinate input surface 12. The coordinate input surface 12 may be arranged above a display 13b and may be a touch screen. The physical size of the coordinate input surface 12 is not limited in the invention. However, in one embodiment, the width of the coordinate input surface 12 is comprised between 2 and 20 centimetres and the height of the coordinate input surface 12 is comprised between 2 and 10 centimetres. Likewise, the screen size resolution of a display 13b is not limited in the invention.

In one embodiment, the coordinate input surface 12 and the display 13b form a touch screen, i.e. a coordinate input surface 12 and display 13b accompanied by electronic means, electromechanical means or the like to detect the presence and determine the location of an object, such as one or more fingers (multitouch interaction), a stylus or an input pen, on the coordinate input surface 12. The touch screen enables direct interaction between the object and the coordinate input surface 12, and the display 13b underneath the coordinate input surface 12, without using an additional mouse or touchpad.

Although the apparatus 10 is illustrated in FIG. 1a with an antenna, the apparatus 10 need not be provided with wireless communication means. In one embodiment, the apparatus 10 is provided with wireless communication means. In another embodiment, the apparatus 10 is not provided with wireless communication means.

FIG. 1b schematically illustrates a coordinate input surface 12 and a display 13b of an apparatus 10 in one embodiment of the invention. The coordinate input surface 12 is the outer surface of the layer 13a, which may be a protective layer of the display 13b, i.e. a protective layer of active display elements forming the display 13b. The layer 13a may include means to detect or means to assist in detecting the position of a finger or other object placed on the coordinate input surface 12. The means may include for instance resistive means, capacitive means or a medium to enable propagation of surface acoustic waves in order to detect or to assist in detecting the position of the finger or other object placed on the coordinate input surface 12. This does not exclude that the means suitable to detect the position of a finger or other object placed on the coordinate input surface 12 are also suitable for detecting the position of a finger or other object placed slightly above the coordinate input surface 12, i.e. not strictly speaking touching the coordinate input surface 12.

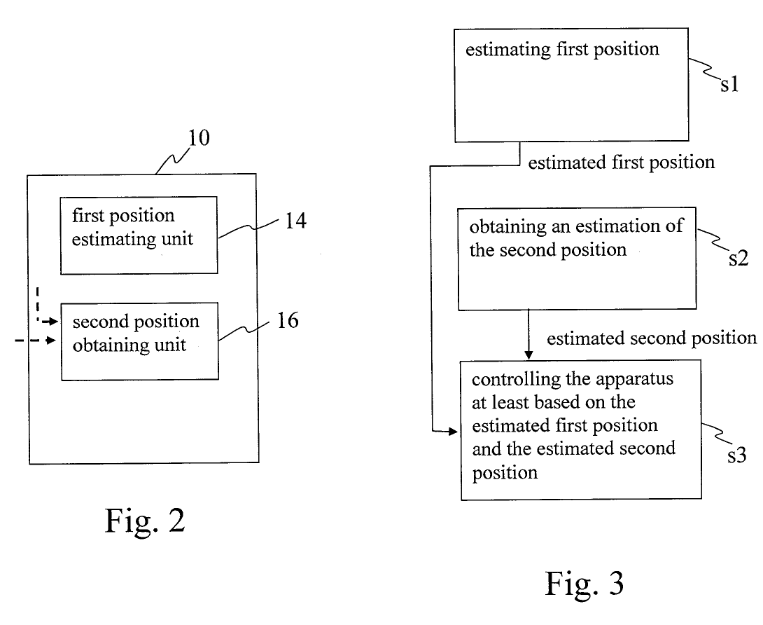

FIG. 2 schematically illustrates an apparatus 10 and some of its constituent elements in one embodiment of the invention. The apparatus 10 includes a first position estimating unit 14 and a second position obtaining unit 16.

The first position estimating unit 14 is configured for estimating the position, which is here referred to as first position 14ₚ, of at least one object on the coordinate input surface 12, which may be arranged above the display 13b, i.e. above the active display layer 13b. The estimated first position 14ₚ is used to control the apparatus 10.

The second position obtaining unit 16 is configured for obtaining (i.e. generating, obtaining, receiving, or being inputted with) an estimation of the position, which is here referred to as second position 16ₚ, of the location at which or towards which a user is looking on the coordinate input surface 12. A user may be the user who is using the apparatus 10 and is holding it. The two illustrated dotted arrows arriving at the second position obtaining unit 16 indicate that the information constituting the estimated second position 16ₚ may be received from another unit included in the apparatus 10 or, alternatively, may be received or obtained from a unit which is external to the apparatus 10.

The estimated first position 14ₚ and estimated second position 16ₚ are used in combination to control the apparatus 10. The use of the estimated first position 14ₚ and estimated second position 16ₚ in combination to control the apparatus 10 may be occasional, in the sense that the use complements the use of the estimated first position 14ₚ alone to control the apparatus 10, or in the sense that the use complements the use of the estimated second position 16ₚ alone to control the apparatus 10.

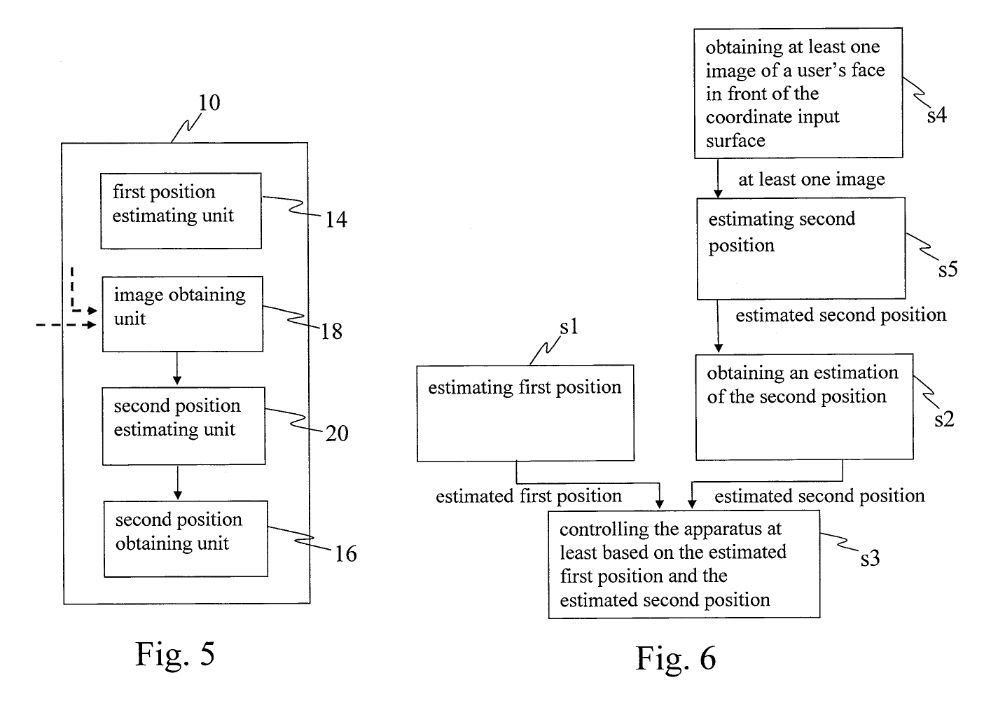

Available solutions to implement the functionalities of second position estimating unit 16 and the second position estimating step s5 (which will be described with FIG. 5 notably), i.e. techniques to estimate the second position 16ₚ corresponding to where the user is looking at, or towards where, on the coordinate input surface 12, include the following exemplary solutions.

First, the company TOBII Technology AB based in Danderyd, Sweden, has developed the so-called T60 and T120 eye trackers which may be used or adapted for use in the apparatus 10 in one embodiment of the invention.

Second, the approach proposed in Kaminski J. Y. et al, Three-Dimensional Face Orientation and Gaze Detection from a Single Image, arXiv:cs/0408012v1 [cs.CV], 4 Aug. 2004, may be used. The approach uses a model of the face, deduced from anthropometric features. Section 2 of this paper presents the face model and how this model may be used to compute the Euclidean face 3D orientation and position. FIG. 6 in this paper shows a system flow to estimate the gaze direction.

Third, the solution proposed in Kaminski J. Y. et al, Single image face orientation and gaze detection, Machine Vision and Applications, Springer Berlin/Heidelberg, ISSN 0932-8092, June 2008, may also be used.

Other solutions may be used based on detecting the head orientation, different parts of the eyes, the nose, and other different parts of the face, or artefacts on the face.

In one embodiment, the gaze direction in an absolute physical frame of reference need not be known to estimate the second position 16ₚ. In this embodiment, by tracking during an interval of time the variation of gaze directions of the user, a mapping between the maximal range of locations on the coordinate input surface 12, or on the display 13b, and the maximal range of angular gaze directions may be used. That is, by assuming that, during an interval of time, the user is constantly or mostly looking at some points within the boundaries of the coordinate input surface 12, the range of variation of gaze directions may be recorded. This may then be used as an indication of where the user currently looks at on the coordinate input surface 12 depending on the current gaze direction.

In one embodiment, the user's eye gaze is detected (and may be possibly tracked in time) for controlling the user interface input process, where the gaze assists the user interface input process without requiring a conscious motor control task from the eyes. That is, the user is not necessarily conscious that his or her gaze is used to assist in controlling the user interface interaction. Since, in this embodiment, the role of eye gaze detection and/or tracking may be of assistance only, the interruption during a period of time of the eye gaze detection is not prejudicial to controlling the apparatus 10 based on the estimated first position 14ₚ only. For instance, if the conditions for image capture are at one point in time insufficient to precisely detect the second position, for instance due to particular lighting condition, the gaze need not be used for user interface control and the user interface interaction is not interrupted.

FIG. 3 is a flowchart illustrating steps performed in a method in one embodiment of the invention. The steps may be configured to be carried out by the apparatus of FIG. 2.

In step s1, the first position is estimated. That is, the position of at least one object, such as one or more fingers, a stylus or an input pen, placed upon on the coordinate input surface 12, which may be an outer surface arranged above a display 13b, is estimated.

In step s2, an estimation of the second position 16ₚ, i.e. the position at which, or towards which, a user is looking on the coordinate input surface 12, is obtained or received.

In step s3, the estimated first position 14ₚ and the estimated second position 16ₚ are then used to control the apparatus 10. For instance, the estimated first position 14ₚ and the estimated second position 16ₚ are used to provide a command to the apparatus 10 in response to a user interacting with the apparatus 10, and especially in relation to the content of what is displayed on the display 13b of the apparatus 10.

The step s1 of estimating the first position 14ₚ and the step s2 of obtaining an estimation of the second position 16ₚ may be performed in any order. In one embodiment, step s1 and step s2 are performed simultaneously or substantially simultaneously.

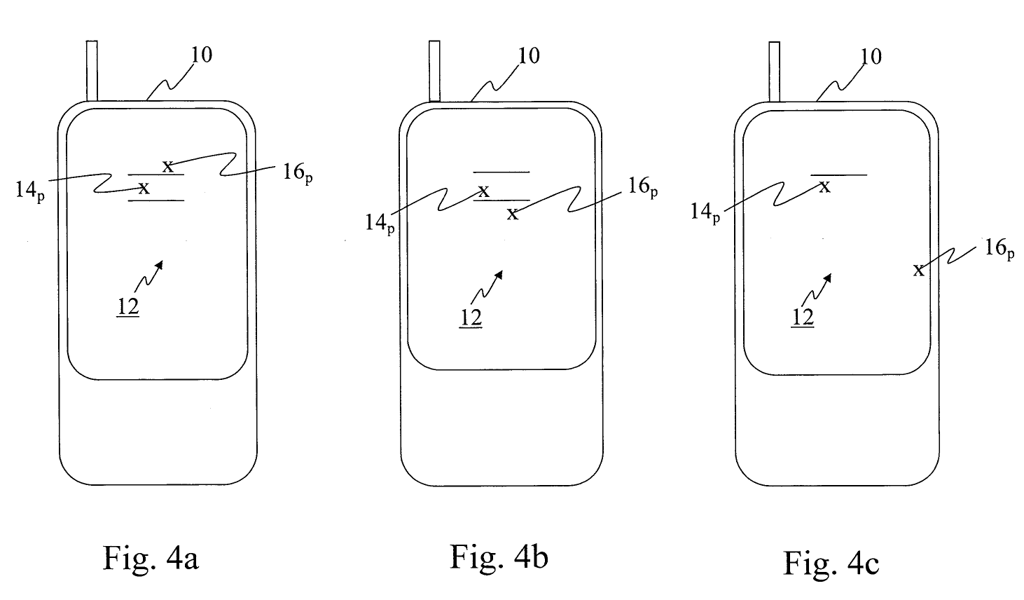

FIGS. 4a to 4c schematically illustrate three situations wherein the estimated first position 14ₚ and the estimated second position 16ₚ are used in combination to control the apparatus 10.

Through the coordinate input surface 12, in the three figures, the content of what is displayed on the display 13b, i.e. the display content, is visible. The straight horizontal segments each schematically represent an exemplary target that a user may select, or may wish to select, in the display content. A target may for instance be a HTML link in a web page represented on the display content. The targets may however be any elements of the image represented on the display content. Namely, a target may be a particular part, region, point, character, symbol, icon or the like shown on the display content.

In FIG. 4a, two targets are shown. Between the two targets, the estimated first position 14ₚ is illustrated by a diagonal cross having the form of the character “x” (the “x” does not however form part of the display content but only represents the estimated first position 14ₚ). Above the first target, the estimated second position 16ₚ is also illustrated, also by a diagonal cross having the form of the character “x” (which also does not form part of the display content but only represents the estimated second position 16ₚ). In this situation, a user may have used his or her finger with the intention to select one of the two targets shown on the display content. The finger input may however be determined to be ambiguous in that it is not possible from the finger input alone, i.e. from the first position 14ₚ alone, to determine which one of the two targets the user wishes to select.

The estimated second position 16ₚ is used, if possible, to disambiguate the input. In the situation illustrated in FIG. 4a, it may be determined that the first target (on the top) is the one that the user most probably wishes to select. If it is not possible to disambiguate the user's input based on the combination of the first position 14ₚ and second position 16ₚ, the apparatus 10 may be controlled by zooming in the display content around the first and second targets to offer the opportunity to the user to more precisely select one of the two targets. The zooming in operation may be performed automatically in response to a determination that an input is ambiguous and that it cannot be resolved.

In FIG. 4b, in contrast, the result of the combined use of the first position 14ₚ and second position 16ₚ may be the determination that the second target (the one below the first one) is the one that the user most likely wishes, i.e. intends, to select.

FIG. 4c schematically illustrates a situation where only one target is in the vicinity of the estimated first position 14ₚ. In addition, the estimated second position 16ₚ may be determined to be located relatively far from the target, as illustrated. The result of the combined use of the first position 14ₚ and second position 16ₚ may be the determination that the user most likely does not wish to select the illustrated target, but rather wishes to pan the display content in the direction of the location where he or she is looking on the coordinate input surface 12, i.e. where he or she is looking at in the display content, or in other words in the direction of the estimated second position 16ₚ.

In one embodiment, when the display content includes at least two targets, as shown for instance in FIGS. 4a and 4b, the estimated second position 16ₚ may be used only when it is determined the at least two targets are within a threshold distance of the estimated first position 14ₚ. If so, the apparatus 10 may be controlled by selecting the target which is the closest to the estimated second position 16ₚ.

Alternatively, a third position being a weighted average of the estimated first position 14ₚ and the estimated second position 16ₚ may be computed to determine the location on the display content that the user most probably wishes to select.

In one embodiment, a determination that the estimated first position 14ₚ is moving on the surface of the coordinate input surface 12 at a speed being above a predetermined threshold speed results in a determination that the user wishes to pan the display content. The estimated second position 16ₚ may then be used in combination with the estimated first position 14ₚ in order to control the apparatus 10 accordingly. If the estimated second position 16ₚ is near an edge of the coordinate input surface 12, this may be determined to be an indication that the user wishes to pan the display content in the direction of the estimated second position 16ₚ. This may be used to control the apparatus 10 accordingly.

Other operations, such as for instance drag and drop operations, may also generally be controlled based on the combination of the estimated first position 14ₚ and estimated second position 16ₚ, and possibly depending on the display content. Disambiguating between, or improving the detection or precision of, panning actions, tap actions (movement of finger, stylus or pen onto a spot of the display content, which may be intended to select or deselect the item which is tapped; alternatively, when an item is selected, a tap in the background of the display content may lead to deselecting the selected item), encircling actions, scratch-out actions (movement in zig-zag, back-and-forth, etc) or any other actions or scenarios is also within the scope of the invention.

The estimated second position 16ₚ may be used as explained above, because users look at what they are working on and eye gaze contains information about the current task performed by an individual, as explained for instance in Sibert, L. E. et al, Evaluation of eye gaze interaction, Proceedings of the ACM CHI 2000 Human Factors in Computing Systems Conference (pp. 281-288), Addison-Wesley/ACM Press, see page 282, left-hand column, lines 1-2 and 10-11.

FIG. 5 schematically illustrates an apparatus 10 in one embodiment of the invention. The apparatus 10 illustrated in FIG. 5 differs from the one illustrated in FIG. 2 in that in addition to the first position estimating unit 14 and the second position obtaining unit 16, the apparatus 10 includes an image obtaining unit 18 and a second position estimating unit 20.

The image obtaining unit 18 is configured for obtaining at least one image of a user's face facing the coordinate input surface 12 through which the display 13b is visible, if provided. To obtain at least one image of a user's face, the image obtaining unit 18 may be configured for obtaining at least one image of at least part of the environment in front of the coordinate input surface 12. The two illustrated dotted arrows arriving at the image obtaining unit 18 symbolically indicate that the image or images may be obtained or received by the image obtaining unit 18 from a unit which is external to the apparatus 10 or, alternatively, from a unit included in the apparatus 10.

The second position estimating unit 20 is configured for estimating, based on the at least one image received by the image obtaining unit 18, the second position 16ₚ. In other words, the estimation of the second position 16ₚ from the input image or images is performed within the apparatus 10.

FIG. 6 is a flowchart illustrating steps carried out in a method in one embodiment of the invention. The steps may be carried out by the apparatus 10 illustrated in FIG. 5. Steps s1, s2 and s3 are identical to those described with reference to FIG. 3. The flowchart of FIG. 6 additionally illustrates a step s4 of obtaining at least one image of a user's face facing the coordinate input surface 12. Then, in step s5, the second position 16ₚ is estimated based on the at least one image. The estimated second position 16ₚ is then received or obtained in step s2 for use, in combination with the estimated first position 14ₚ (estimated in step s1), to control the apparatus 10 (step s3).

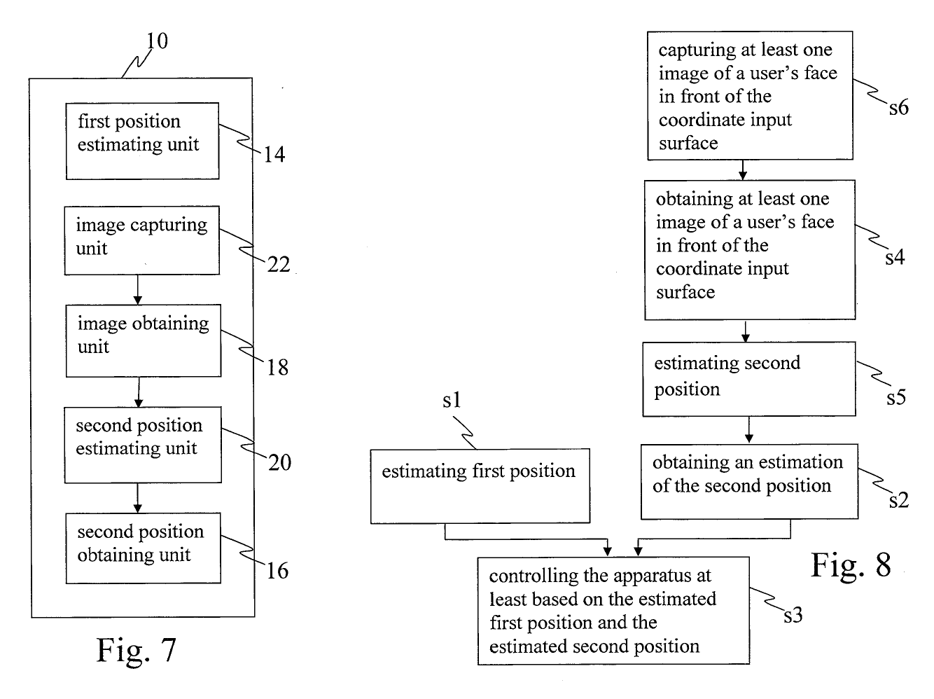

FIG. 7 schematically illustrates an apparatus 10 in one embodiment of the invention. Compared to the apparatus 10 illustrated in FIG. 5, the apparatus 10 illustrated in FIG. 7 includes an image capturing unit 22. The image capturing unit 22 is configured for capturing at least one image of a user's face facing the coordinate input surface 12. The user of apparatus 10 of the apparatus 10 is normally visible in the environment in front of the coordinate input surface 12.

FIG. 8 is a flowchart illustrating steps carried out in a method in one embodiment of the invention. The steps may be carried out by the apparatus 10 illustrated in FIG. 7. In addition to steps s1, s2, s3, s4 and s5 described with reference to FIGS. 3 and 6, the flowchart of FIG. 8 additionally illustrates a step s6 of capturing at least one image of a user's face facing the coordinate input surface 12, which may be carried out by capturing at least one image of the environment in front of the coordinate input surface 12. The image or images are received or obtained in step s4 for use in step s5 to estimate the second position 16ₚ. The estimated second position 16ₚ is used in combination with the estimated first position 14ₚ for controlling the apparatus 10, in step 3.

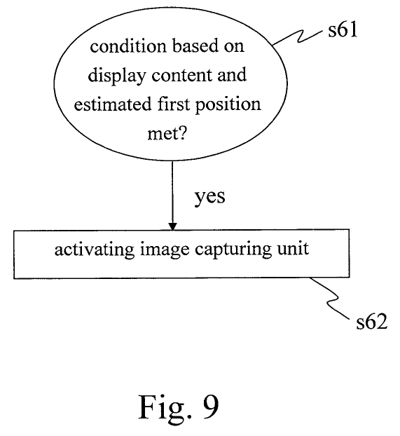

FIG. 9 is a flowchart illustrating the process of determining s61 whether a condition based on the display content and the estimated first position 14ₚ is met. If so, in step s62, the image capturing process is activated, or the image capturing unit 22 is activated or switched on, for capturing at least one image from the environment in front of the coordinate input surface 12.

In one embodiment, the condition for activating the image capturing process, or for activating or switching on the image capturing unit 22, includes that at least two targets in the display content are within a predetermined distance of the estimated first position 14ₚ.

In one embodiment, the condition for activating the image capturing process, or for activating or switching on the image capturing unit 22, includes that the estimated first position 14ₚ is determined to be moving. The condition may more precisely be that the estimated first position 14ₚ is determined to be moving above a predetermined speed. The motion, or the speed corresponding to the motion, of the estimated first position 14ₚ may be computed by tracking in time (or obtaining at regular intervals) the estimated first position 14ₚ.

In one embodiment (not illustrated in the drawings), if more than one faces are detected when attempting to estimate the second position 16ₚ corresponding to where the user is looking at, or towards, on the coordinate input surface 12, a prioritization process is carried out. Namely, if more than one face is detected, the apparatus prioritizes which face should be used to control the apparatus 10 using the image capturing unit 22 and the second position estimation unit 20. The prioritization may for instance be based on the size of the detected face (the biggest face is most likely to be the one closest to the apparatus 10, and thus also belonging to the person using the apparatus 10), based on which face is the closest to the center of the camera's field of view (the person appearing closest to the center of the camera's field of view is most likely to be the person using the apparatus 10), or based on recognizing a face recorded in the apparatus 10 (the owner of the apparatus 10 may be known and may be recognizable by the apparatus 10). In one embodiment, if the selected prioritization technique (or a combination of them) fails, the image or images of the image capturing unit 22 is not or are not used for controlling the apparatus 10.

The physical entities according to the invention, including the apparatus 10, may comprise or store computer programs including instructions such that, when the computer programs are executed on the physical entities, steps and procedures according to embodiments of the invention are carried out. The invention also relates to such computer programs for carrying out methods according to the invention, and to any computer-readable medium storing the computer programs for carrying out methods according to the invention.

Where the terms “first position estimating unit”, “second position obtaining unit”, “image obtaining unit”, “second position estimating unit”, and “image capturing unit” are used herewith, no restriction is made regarding how distributed these units may be and regarding how gathered units may be. That is, the constituent elements of the above first position estimating unit, second position obtaining unit, image obtaining unit, second position estimating unit, and image capturing unit may be distributed in different software or hardware components or devices for bringing about the intended function. A plurality of distinct elements may also be gathered for providing the intended functionalities.

Any one of the above-referred units of an apparatus 10 may be implemented in hardware, software, field-programmable gate array (FPGA), application-specific integrated circuit (ASICs), firmware or the like.

In further embodiments of the invention, any one of the above-mentioned and/or claimed first position estimating unit, second position obtaining unit, image obtaining unit, second position estimating unit, and image capturing unit is replaced by first position estimating means, second position obtaining means, image obtaining means, second position estimating means, and image capturing means respectively, or by a first position estimator, a second position obtainer, an image obtainer, a second position estimator, and an image capturer respectively, for performing the functions of the first position estimating unit, second position obtaining unit, image obtaining unit, second position estimating unit, and image capturing unit.

In further embodiments of the invention, any one of the above-described steps may be implemented using computer-readable instructions, for instance in the form of computer-understandable procedures, methods or the like, in any kind of computer languages, and/or in the form of embedded software on firmware, integrated circuits or the like.

Although the present invention has been described on the basis of detailed examples, the detailed examples only serve to provide the skilled person with a better understanding, and are not intended to limit the scope of the invention. The scope of the invention is much rather defined by the appended claims.

1. Electronic apparatus including
a coordinate input surface on which at least a finger of a user can be placed;
a first position estimating unit for estimating the position, here referred to as first position, of at least one object placed on the coordinate input surface; and
a second position obtaining unit for obtaining an estimation of the position, here referred to as second position, at which a user is looking on the coordinate input surface;
wherein the apparatus is configured to be controlled at least based on the combination of the estimated first position and the estimated second position.

2. Apparatus of claim 1, further including a display;
wherein the coordinate input surface is an outer surface above the display.

3. Apparatus of claim 2, further including
an image obtaining unit for obtaining at least one image of a user's face facing the coordinate input surface; and
a second position estimating unit for estimating, based on the at least one image, the second position.

4. Apparatus of claim 3, further including an image capturing unit for capturing the at least one image.

5. Apparatus of claim 4, wherein
the image capturing unit is arranged to capture the at least one image when a condition is met; and
the condition depends on the content of what is displayed on the display, here referred to as display content, and the estimated first position.

6. Apparatus of claim 5, wherein the condition includes that at least two targets in the display content are within a predetermined distance of the estimated first position.

7. Apparatus of claim 6, wherein
the display content includes at least one of a web page, a map and a document, and
the at least two targets are at least two links in the display content.

8. Apparatus according to claim 5, wherein the condition includes that the estimated first position is determined to be moving.

9. Apparatus according to claim 2, arranged to be controlled,
when at least two targets in the content of what is displayed on the display, here referred to as display content, are determined to be within a threshold distance of the estimated first position,
by selecting one of the at least two targets based on the estimated second position.

10. Apparatus of claim 9, wherein selecting one of the at least two targets based on the estimated second position includes selecting, among the at least two targets, the target being the closest to the estimated second position.

11. Apparatus of claim 9, wherein
the display content includes at least one of a web page, a map and a document, and
the at least two targets are at least two links in the display content.

12. Apparatus according to claim 2, arranged to be controlled,
when the estimated first position is determined to be moving and the estimated second position is determined to be near an edge of the coordinate input surface,
by panning the content of what is displayed on the display, here referred to as display content, in the direction of the estimated second position.

13. Apparatus according to claim 1, being at least one of a mobile phone, an audio player, a camera, a navigation device, an e-book device, a computer, a handheld computer, a personal digital assistant, a game console, and a handheld game console.

14. System including
an apparatus of claim 1;
an image capturing unit arranged with respect to the apparatus so as to be capable of capturing at least one image of a user's face facing the coordinate input surface of the apparatus;
an image obtaining unit for obtaining the at least one image; and
a second position estimating unit for estimating, based on the at least one image, the second position;
wherein at least the image capturing unit is not integrally formed with the apparatus.

15. System of claim 14, wherein the image capturing unit, the image obtaining unit and the second position estimating unit are not integrally formed with the apparatus.

16. Method of controlling an electronic apparatus including a coordinate input surface on which at least a finger of a user can be placed, the method including steps of
estimating the position, here referred to as first position, of at least one object placed on the surface of the coordinate input surface;
obtaining an estimation of the position, here referred to as second position, at which a user is looking on the coordinate input surface; and
controlling the apparatus at least based on the combination of the estimated first position and the estimated second position.

17. Method of claim 16, wherein the apparatus further includes a display and wherein the coordinate input surface is an outer surface above the display.

18. Method of claim 17, further including, before the step of obtaining an estimation of the second position, steps of
obtaining at least one image of a user's face facing the coordinate input surface; and
estimating, based on the at least one image, the second position.

19. Method of claim 18, further including, before the step of obtaining at least one image of a user's face facing the coordinate input surface, a step of capturing the at least one image.

20. Method of claim 19, wherein
the at least one image is captured when a condition is met; and
the condition depends on the content of what is displayed on the display, here referred to as display content, and the estimated first position.

21. Method of claim 20, wherein the condition includes that at least two targets in the display content are within a predetermined distance of the estimated first position.

22. Method of claim 21, wherein
the display content includes at least one of a web page, a map and a document, and
the at least two targets are at least two links in the display content.

23. Method according to claim 20, wherein the condition includes that the estimated first position is determined to be moving.

24. Method according to claim 17, wherein the apparatus is controlled,
when at least two targets in the content of what is displayed on the display, here referred to as display content, are determined to be within a threshold distance of the estimated first position,
by selecting one of the at least two targets based on the estimated second position.

25. Method of claim 24, wherein selecting one of the at least two targets based on the estimated second position includes selecting, among the at least two targets, the target being the closest to the estimated second position.

26. Method of claim 24, wherein
the display content includes at least one of a web page, a map and a document, and
the at least two targets are at least two links in the display content.

27. Method according to claim 17, wherein the apparatus is controlled,
when the estimated first position is determined to be moving and the estimated second position is determined to be near an edge of the coordinate input surface,
by panning the content of what is displayed on the display, here referred to as display content, in the direction of the estimated second position.

28. Computer program comprising instructions configured, when executed on a computer, to cause the computer to carry out the method according to claim 16.
